(19) United States
(12) Patent Application Publication
(10) Pub. No.: US 2016/0036940 A1
(43) Pub. Date: Feb. 4, 2016

(54) COMPUTING DEVICE OPERABLE IN SEPARATE MODES IN CONNECTION WITH UTILIZING A NETWORK SERVICE

(71) Applicant: Kobo Inc., Toronto (CA)

(72) Inventor: James Wu, Newmarket (CA)

(21) Appl. No.: 14/448,914

(22) Filed: Jul. 31, 2014

(51) Int. Cl. H04L 29/08; H04L 12/24

(52) U.S. Cl. CPC H04L 67/306; H04L 41/22

(57) ABSTRACT

A computing device is associated with multiple linked accounts for accessing content items from a network service. The multiple accounts can include a primary account and a subordinate account that is available through the primary account. When the computing device uses the primary account and not the subordinate account, the computing device is operated in a first mode which defines a first set of input features. When the computing device uses the subordinate account, the computing device is operated in a second mode in which a second set of input features and a corresponding second set of functionality for the second input features are provided in order to render content from the network service on the computing device.

### TECHNICAL FIELD

Examples described herein relate to a mufti-modal computing device, and more specifically to a computing device that is operable to have separate modes of operation in connection with utilizing a network service.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

Some electronic personal display devices are purpose built devices that are designed to perform especially well at displaying readable content. For example, a purpose built purpose build device may include a display that reduces glare, performs well in high lighting conditions, and/or mimics the look of text on actual paper. While such purpose built devices may excel at displaying content for a user to read, they may also perform other functions, such as displaying images, emitting audio, recording audio, and web surfing, among others.

There also exists numerous kinds of consumer devices that can receive services and resources from a network service. Such devices can operate applications or provide other functionality that links a device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for enabling a mufti-modal e-reading device that provides different sets of input functionality, according to an embodiment.

FIG. 2 illustrates an example of an e-reading device for use with one or more embodiments described herein.

FIG. 3 illustrates an example device system for enabling multi-modal functionality on an e-reading device in connection with different network accounts that are linked to the e-reading system, according to an embodiment.

FIG. 4 illustrates an example method for configuring input features of an e-reading device based on an account that is in use on the device, according to an embodiment.

FIG. 5A illustrates an e-reading device that is operated in a primary mode, coinciding with use of a primary account on the e-reading device, according to an embodiment.

FIG. 5B illustrates an e-reading device that is operated in a secondary mode, coinciding with use of a subordinate account on the e-reading device, according to an embodiment.

### DETAILED DESCRIPTION

Examples described herein provide for a computing device that is operable in multiple modes, in which each mode provides a different set of input features for use with services and content provided from a network service. According to one example, an e-reading device can be linked to multiple different accounts provided by a same service, and the e-reading device implements a different mode of operation with the use of each account. As a more specific example, the e-reading device can be linked with a primary account and a subordinate account of a network service, and the e-reading device can operate to implement different modes of operation for each of the network accounts.

According to some embodiments, a computing device is associated with multiple linked accounts for accessing content items from a network service. The multiple accounts can include a primary account and a subordinate account that is available through the primary account. When the computing device uses the primary account and not the subordinate account, the computing device is operated in a first mode in which a first set of input features and a corresponding first set of functionality are provided in order to render content from the network service on the computing device. When the computing device uses the subordinate account, the computing device is operated in a second mode in which a second set of input features and a corresponding second set of functionality are provided in order to render content from the network service on the computing device.

“E-books” are a form of an electronic publication that can be viewed on computing devices with suitable functionality. An e-book can correspond to a literary work having a pagination format, such as provided by literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., e-reading apps) to view e-books. Still further, some devices (sometimes labeled as “e-readers”) can be centric towards content viewing, and e-book viewing in particular.

An “e-reading device” can refer to any computing device that can display or otherwise render an e-book. By way of example, an e-reading device can include a mobile computing device on which an e-reading application can be executed to render content that includes e-books (e.g., comic books, magazines etc.). Such mobile computing devices can include, for example, a mufti-functional computing device for cellular telephony/messaging (e.g., feature phone or smart phone), a tablet device, an ultramobile computing device, or a wearable computing device with a form factor of a wearable accessory device (e.g., smart watch or bracelet, glasswear integrated with computing device, etc.). As another example, an e-reading device can include an e-reader device, such as a purpose-built device that is optimized for e-reading experience (e.g., with E-ink displays etc.).

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Overview

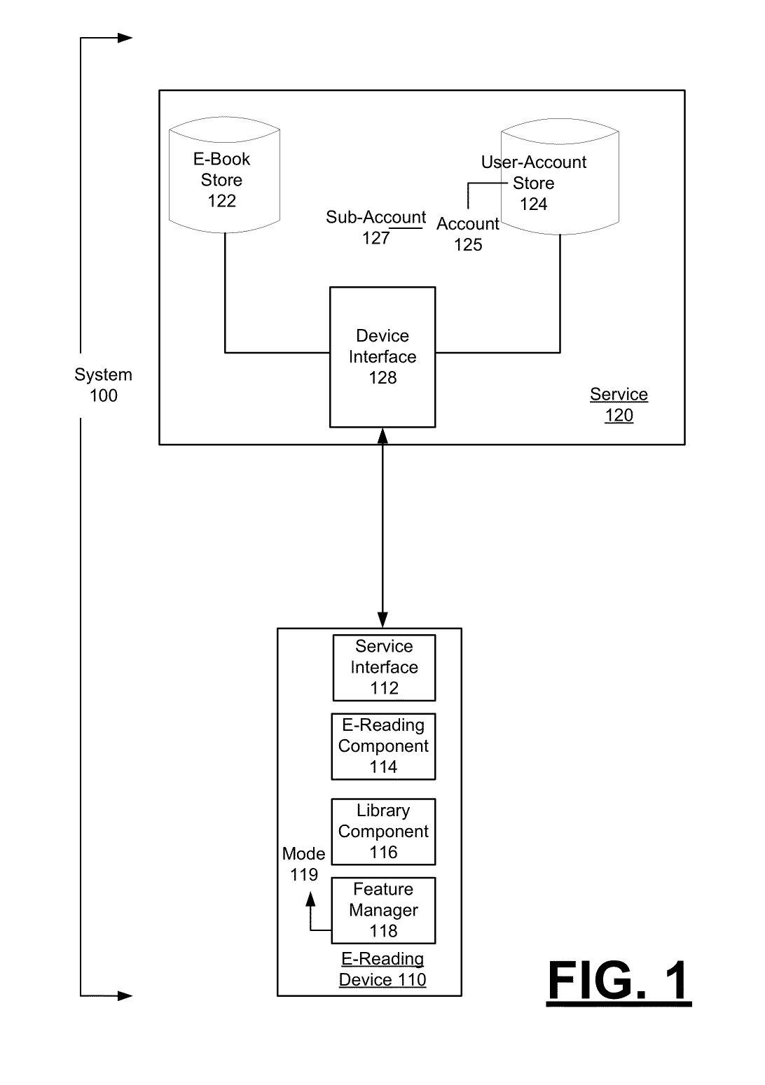

FIG. 1 illustrates a system for enabling a mufti-modal e-reading device that provides different sets of input functionality, according to an embodiment. As described in greater detail, the e-reading device 110 can link to multiple accounts 125, 127 provided through a network service 120. The multiple accounts can include a subordinate account 127 that is available only through the primary account 125. As described with examples, the e-reading device 110 can configure input features for e-books and other content based on the account that is in use at a particular time. By way of example, a subordinate account can be provided for a child to use on an e-reading device in connection with the device's use with another account (e.g., the child's parent) on the same network service 120. When the subordinate account is in use, the input features of the e-reading device 110 can be configured to be child-friendly. When the subordinate account is in use, the input features of the e-reading device can be configured for maximum functionality.

In an example of FIG. 1, system 100 includes an e-reading device 110 and a network service 120. The network service 120 may include multiple servers and other computing resources that provide various services in connection with one or more applications that are installed on the e-reading device 110. By way of example, in one implementation, the network service 120 can provide e-book services which communicate with corresponding e-book functionality provided on the e-reading device 110. The e-book services can enable e-books to be downloaded or archived from e-reading device 110. The network service 120 can also provide other forms of content for download or streaming, such as videos or music. In this way, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can correspond to a mobile computing device (e.g., tablet) that runs an e-reading application to link the device to the network service 120 in order to enable e-books provided through the service to be viewed and consumed. Still further, by way of example, the e-reading device 110 can be equipped with hardware and software to optimize certain application activities, such as rendering of electronic content (e.g., e-books). For example, the e-reading device 110 can have a tablet like form factor, although variations are possible. In some cases, the e-reading device 110 can also have an E-ink display.

In additional detail, the network service 120 can include a device interface 128, a resource store 122 and a user account store 124. The user account store 124 can associate the e-reading device 110 with a user and with one or more accounts 125, 127. The accounts 125, 127 can also be associated with one or more application resources (e.g., content item such as an e-books), which can be stored in the resource store 122. As described further, the user account store 124 can retain metadata for individual accounts 125 to identify resources that have been purchased or made available for consumption for a given account. The e-reading device 110 may be associated with the primary user account 125, and multiple devices may be associated with the same account. As described in greater detail below, the e-reading device 110 can store resources (e.g., e-books) that are purchased or otherwise made available to the user of the e-reading device 110, as well as to archive e-books and other content items that have been purchased for the user account 125, but are not stored on the particular computing device.

According to one aspect, the e-reading device 110 can be associated with a primary account 125 and a subordinate account 127. By way of example, the primary account 125 can be for an adult/parent and the subordinate account 127 can be for a child or minor. In one implementation, the subordinate account 127 can be available only as part of the primary account. As an addition or variation, the primary account 125 can have permissions that are not shared by the subordinate account. For example, the network service 120 can maintain the accounts so that only a user of the primary account 125 can purchase e-books or other content from the network service 120. The user of the subordinate account 127 can be denied permission to purchase e-books from the network service 120 when operating the e-reading device 110. Still further, the primary account 125 can include all of the e-books and content items of the subordinate account 127, while the subordinate account 127 excludes e-books of the primary account. A user can access the network service 120 through a browser or through e-reading device 110, in order to open the account 125, update the account 125, and further establish the subordinate account 127. The user can also designate or assign specific purchases or downloads to the subordinate account 127.

The e-reading device 110 can include a service interface 112, an e-reading component 114, a library component 116 and an input feature manager 118. The e-reading device 110 can execute the service interface 112 to receive resources and data from the network service 120. The service interface 112 can signal the network service 120 an identifier for the user and/or user account. The service interface 112 can interface with the network service 120 to receive resources such as applications and content items (e.g., e-books, music files, etc.) from the network service 120. Optionally, the e-reading device 110 can communicate with multiple services in order to receive resources.

The e-reading device 110 can execute the e-reading component 114 to enable e-reading activities. In particular, the e-reading component 114 can render paginated content from e-books (e.g., electronically formatted literary works, including periodicals).

The library view component 116 can include a user interface that provides a presentation of the content items (e.g., e-books, including magazines and periodicals) in a defined library. The library can include the user's entire collection of e-books, as well as e-books that are being promoted or otherwise displayed through metadata content on the user device. For example, a library can include e-books in a user collection and/or e-books that network service 120 is promoting and/or making available for purchase or download. The presentation of the content items can be based on metadata content associated with the individual content items. For example, in the case of e-books, the metadata content used to display representations of the e-books in the user library can include images provided by the publisher (e.g., icons or graphic objects) which represent or appear as a book cover or jacket. Likewise, in the case of music or movies, representations of the content items in the user's library can be based on icons or graphic objects that represent album art (music) or box cover art (movies).

The e-reading component 114 can also be combined with other functionality that is part of an e-reading suite or library, such as an application for displaying an e-book store, or functionality for enabling the user to browse for e-books and to purchase e-books from the network service. In this way, the e-reading device 110 can include multiple components which can provide various kinds of functionality and services for accessing e-books from the network service 120. When the e-reading device 110 purchases an e-book, the device interface 128 of the network service identifies the primary account 125 associated with the device, and then debits the primary account 125 for the cost of the e-book. At the same time, the network service 120 can associate the purchased e-book with the user account so that it is available to the e-reading device 110 for download. The user can also associate the purchased e-book with either the primary account 125 or the subordinate account 127, and the purchased e-book can be added to the library of the e-reading device 110.

According to one aspect, the e-reading device 110 operates a session or instance through one of multiple accounts 125, 127 provided through the network service 120. Each account can provide the user access to different resources provided by the network service 120. In one implementation, the user can operate the e-reading device 110 using the primary account 125, in order to obtain access to the network service 120 (e.g., browse and purchase e-books, download archived or free e-books, archive e-books stored on the e-reading device 110, write review or update social status through the network service 120, credit account or provide account information, etc.). Additionally, when the e-reading device 110 is operated through the primary account 125, the e-reading device 110 can access an entire library of the user's purchased or downloaded e-books. Conversely, according to one implementation, the e-reading device 110 can be operated through subordinate account 127 (e.g., children's account) in order to have a more limited access to resources provided by the network service 120. By way of example, when the e-reading device 110 is operated through the subordinate account 127, the e-reading device may have limited (e.g., password protected, or limited access to e-books that are suitable for the class of user) or no access to the network service 120. Furthermore, the e-reading device 110 can only make available those e-books which are assigned to the subordinate account 127, rather than all e-books available to the primary account 125. Thus, in an example in which the subordinate account is a child or minor's account, the e-reading device 110 has limited ability to, for example, enable local or network access to e-books that are not suitable for a child.

According to some embodiments, the e-reading device 110 afters the input functionality provided through the physical input features and through the applications (e.g., through e-reading component 114). The alternation to the input functionality can be based on the account that is in use on the device, as well as on information that is known or assumed about the user of the account in use. The feature manager 118 can operate to select, configure and/or define input features (including their respective functionality) depending on the account in use on the device at a particular instance. When the e-reading device 110 is used with the primary account 125, the set of input features can be based on a default and primary set of settings (which can optionally be configurable by the user). When the e-reading device 110 is used with the secondary or subordinate account 127, the set of input features can be selected to conform to a perceived capability of a user class for the subordinate account. For example, the feature manager 118 can select, configure and/or define input features (e.g., assign function to action by user, provide software-based object with assigned function) of the e-reading device 110 for the capability of a child of a certain age (e.g., 6-8 years old). The feature manager 118 can also reconfigure, disable or after the input features provided with the primary account 125 in order to preclude access to content that is not appropriate for the class of user associated with the subordinate account.

In one implementation, the user of the primary account 125 provides input on either the e-reading device 110, or on the network service 120, in order to identify the user of the subordinate account. A class of the user of the subordinate account can also be identified, either directly (through input of the user of the primary account 125) or indirectly (e.g., through response by the user to alternative questions). By way of example, the user class can identify the user of the subordinate account as being under 12, between the ages of 6 and 9, or a minor.

In one embodiment, the feature manager 118 defines multiple modes 119 of operation, where each mode of operation includes a particular set of input features. Each set of input features for a particular mode can correspond to a selection, configuration or definition of a set of input features. In one implementation, the subordinate account 127 can be associated with a specific alternative mode (e.g., children under 12). In variations, multiple subordinate accounts can be maintained, each associated with a different class of user. In such variations, the alternative modes 119 can vary based on the class of user for the particular subordinate account. For example, one subordinate account 127 can be provided for a child under 12 and another subordinate account can be provided for a child under 8. The feature manager 118 can implement different modes for providing input features through each account, based on the class of user associated with each account.

According to one embodiment, the e-reading device 110 determines the mode 119 of operation based on user input. For example, when the user switches the e-reading device 110 to an active power state (e.g., from sleep) and then select a user, the selection of the user at this stage can set the device's mode of operation. Furthermore, when the device is in use, the user can select a different account. When the primary account 125 is selected, the user may be required to provide a password or provide other authentication in order to protect against the user of the subordinate account inadvertently accessing resources of the network service 120 provided through the primary account 125.

As an alternative or variation, the e-reading device 110 determines the mode 119 of operation based on biometric data. For example, the e-reading device 110 can include a fingerprint sensor or retina scanner that automatically identifies the user as being that of the primary account 125, or alternatively the user of the subordinate account 127. When the user is identified, the e-reading device 110 can be operated through the account provided for that user, and the feature manager 118 can automatically implement the mode 119 for the account of the user.

Hardware Description

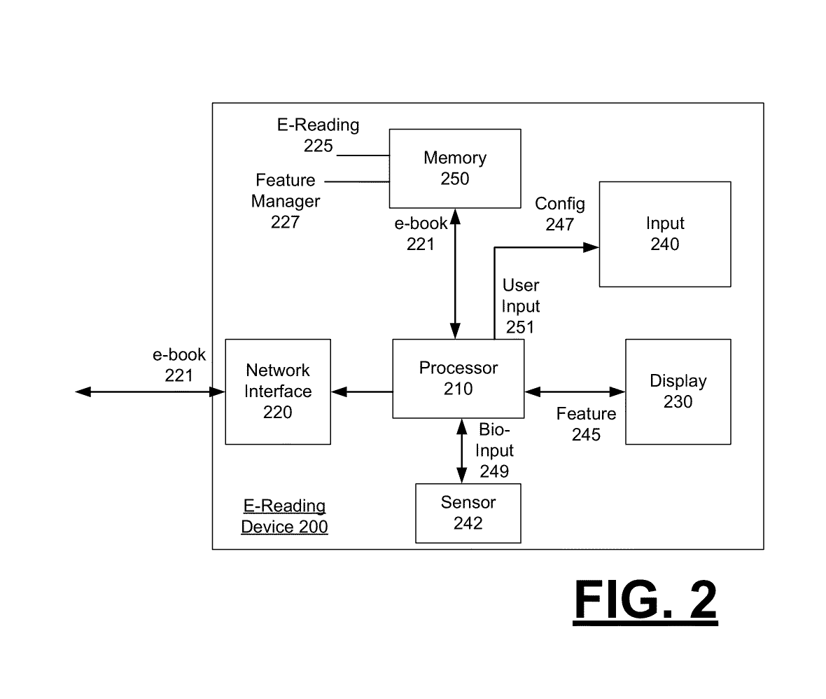

FIG. 2 illustrates an example of an e-reading device for use with one or more embodiments described herein. In an example of FIG. 2, an e-reading device 200 can correspond to, for example, an e-reading device such as shown by an example of FIG. 1.

With reference to FIG. 2, e-reading device 200 includes a processor 210, a network interface 220, a display 230, one or more physical input mechanisms 240, and a memory 250. The processor 210 can implement functionality using instructions stored in the memory 250. Additionally, in some implementations, the processor 210 utilizes the network interface 220 to communicate with the network service 120 (see FIG. 1). More specifically, the e-reading device 200 can access the network service 120 to receive various kinds of resources (e.g., content items such as e-books, configuration files, account information), as well as to provide information (e.g., user account information, service requests etc.). For example, e-reading device 200 can receive application resources, such as media files (e.g., e-books 221) that the user elects to purchase or otherwise download from the network service 120. The application resources that are downloaded onto the e-reading device 200 can be stored in the memory 250.

In some implementations, the display 230 can correspond to, for example, a liquid crystal display (LCD) or light emitting diode (LED) display that illuminates in order to provide content generated from processor 210. In some variations, the display 230 can correspond to an electronic paper type display, which mimics conventional paper in the manner in which they display content. Examples of such display technologies include electrophoretic displays, electrowetting displays, and electrofluidic displays.

In some implementations, the display 230 can be touch-sensitive. For example, the display 230 can be integrated with a sensor layer that is comprised of capacitive touch sensors which trigger with contact to human skin. Alternatively, the display 230 can include alternative sensor layers, such as resistive sensors which can detect applied pressure from, for example, a human finger or stylus.

The processor 210 can receive input from various sources, including from physical input mechanisms 240 (e.g., buttons or switches, microphone, keyboard), the display 230 (e.g., soft buttons or virtual keyboard) or other input mechanisms (accessory devices). In one implementation, the processor 210 can process multi-touch input detected by the sensor layer provided on the display 230.

In one aspect, memory 250 stores instructions 225 (“e-reading instructions 225”) for operating an e-reading application (e.g., see e-reader component 114 in FIG. 1). The memory 250 can also store instructions for providing other components or functionality of an e-reading suite.

Additionally, the memory 250 can store instructions for implementing a feature manager (“feature manager instructions 227”). The feature manager instructions 227 can be executed by the processor in order to implement an operation mode on the computing device based on the account that is in use at a particular time. The feature manager instructions 227 are executed by the processor 210 to select, configure and define input features for the e-reading device 200 while the device is operated in the corresponding mode.

The memory 250 can also store e-books 221 that the user has downloaded or otherwise acquired (e.g., from network service 120). In one implementation, the feature manager instructions 227 can execute to limit access to e-books 221 that are not acquired through the subordinate account 127. This allows, for example, a parent's e-book library to be protected from viewing by a child who has access to the e-reading device by way of the subordinate account 127.

The processor 210 can implement one of multiple available operation modes on the e-reading device 110. Each operation mode can be associated with a specific account (or multiple accounts), and the e-reading device can be linked to multiple accounts of different classes provided for use with network service 120. More generally, each account available on the e-reading device can be associated with an account, and the account can be provided for a user of a particular class (e.g., adult versus child).

Additionally, each operation mode can include a corresponding distinct set of input features that are defined with input resources of the e-reading device 200. In an example of FIG. 2, the input resources of the e-reading device can include the display 230 and the physical input mechanisms 240. In particular, when implementing each operating mode, the processor 210 can select, configure or otherwise define a set of software based features 245 for the operation mode to include on the display 230. For example, the operation mode provided with use of the primary account 125 can include icons (and associated functionality), menu items, and a library of designated touches or contacts (e.g., press and hold, swipe, double tap, etc.) which interpret to input. Likewise, the processor can define and provide input functionality for use with physical resources, such as provided with the input mechanisms 240. For example, individual buttons or touch-sensitive regions of the housing can be assigned a function based on the operation mode of the e-reading device. More generally, the processor 210 can also enable or disable physical input features based on the mode of operation. Accordingly, with respect to an example of FIG. 2, the processor 210 can signal configurations 247 to individual input mechanisms 240 in order to select (e.g., enable/disable, configure, select functionality, etc.) the physical input mechanisms 240.

The processor 210 identifies the user in order to determine the account that is in use on the device for a given session, as well as the mode of operation. In one implementation, the user is identified by input 251 provided through, for example, the physical input mechanism 240 or alternatively through the display 230. In a variation, the e-reading device 200 includes one or more sensors 242 which obtain biometric input 249 from the user. Based on the biometric input 249, the user is identified, the account that is to be identified for the session is determined, and the mode of operation is set.

Device System

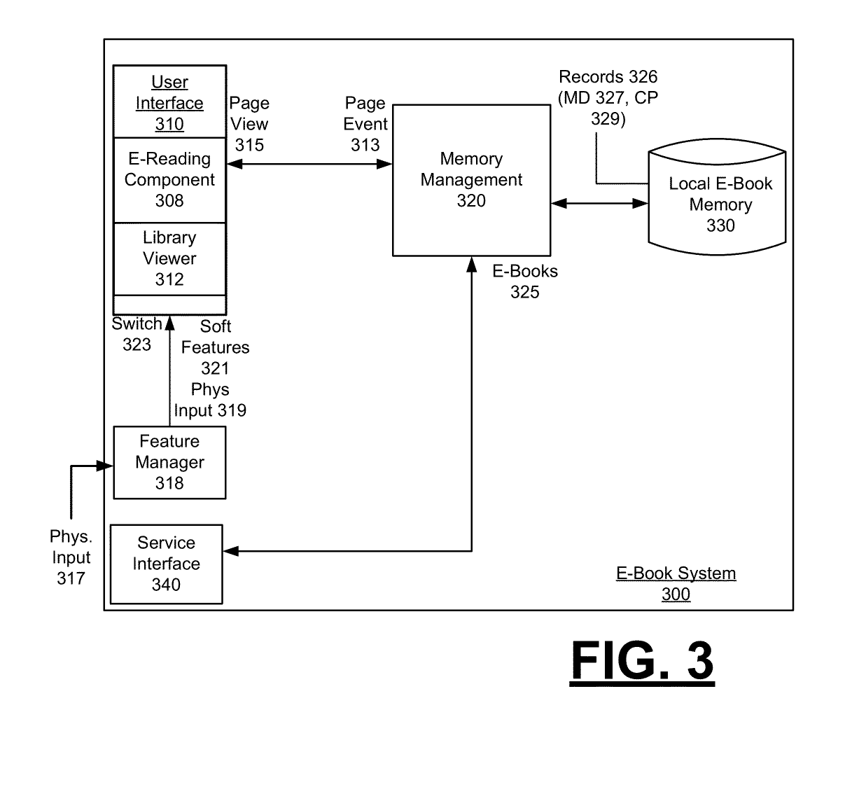

FIG. 3 illustrates an example device system for enabling multi-modal functionality on an e-reading device in connection with different network accounts that are linked to the e-reading system, according to an embodiment. In reference to FIG. 3, a system 300 implements programmatic components for communicating with one or more network service (such as network service 120, shown in FIG. 1), as well as for enabling functionality for viewing and accessing content items (e.g., e-books) utilized by accounts that are associated with the e-reading device 110 (see FIG. 1). As described with other examples, the e-reading system 300 can be linked to multiple accounts, including a primary account and a subordinate account. The functionality and resources provided with the e-reading system 300, as well as the ability of the system to access and use the network service 120, can be determined on a session or instance basis based on the account (e.g., primary or subordinate) that is selected for the user for that session or instance.

In some embodiments, the system 300 can be implemented as an application that runs on an e-reading device, such as shown with examples of FIG. 1 or FIG. 2. In variations, the system 300 can be implemented as part of the operating system for the e-reading device.

In an example of FIG. 3, system 300 includes a user interface 310, a memory management module 320, a local memory 330, and a service interface 340. Some or all of the programmatic components shown with the computing system 300 can be provided in part as operating system-level components. Alternatively, the programmatic components shown with the computing system 300 can be provided as part of an application that runs on, for example, the e-reading device 110 (see FIG. 1). For example, the user can download an application onto the device that is operated as the e-reading device 110, in order to obtain functionality such as described with an example of FIG. 3, as well as to communicate with the network service 120. Alternatively, an application can be embedded or otherwise preinstalled with other programmatic elements for providing functionality such as described with system 300.

The service interface 340 includes application logic which enables the e-reading device 110 to use, for example, a wireless Internet connection, to connect to the network service 120 (see FIG. 1). In connecting with the service, the service interface 340 can transmit data that enables the network service 120 to identify the e-reading device 110 on which system 300 is implemented, so that the network service 120 can determine the primary account that is associated with the particular e-reading device. The service interface 340 can be used to retrieve e-books 325 from the network service 120. For example, in identifying the e-reading device 110 of system 300 to the network service 120, the network service may be able to procure payment information (e.g., stored credit card information) that can be used to charge the user's account when the user purchases a new e-book from the service. Each e-book can correspond to a literary work having a pagination format, such as provided by literary works (e.g., novels) and periodicals (e.g., magazines, comic books, journals, etc.). Optionally, some e-books may have chapter designations, as well as content that corresponds to graphics or images (e.g., such as in the case of magazines or comic books). Individual e-books 325 also include metadata 327, such as imagery provided as a cover for the e-book when the e-book is marketed (e.g. similar to the manner in which a conventional hardbound book would be marketed in a retail store). In one implementation, the network service 120 can retrieve or otherwise identify the imagery and other metadata 327 of individual e-books from publisher sources.

In identifying the e-reading device of system 300, the network service 120 can identify what e-books belong to the account associated with the particular device. The e-books that are transmitted to the e-reading device of system 300 can include, for example, those e-books that are purchased from the device, or those e-books that the user requested to download. In variations, e-books can be automatically downloaded to the device in response to occurrence of certain conditions. For example, the user can purchase an e-book on another device, and then subsequently connect to the network service 120 via the e-reading device 110 to automatically receive their previously purchased e-book. As another example, network service 120 can be configured to push e-books to the e-reading device 110 of system 300, based on, for example, user account settings, subscription plans and rules, and various other business logic considerations.

Additionally, the service interface 340 can include processes for automatically receiving updates from a network service 120. The update can include programmatic updates, including updates to software components on the e-reading device 110, as well as updates to lists, download of e-books that the user may have purchased on another device of the same account, recommendations from the network as to what a given user may want to purchase or view, and/or various other data that can be either generally provided to the user of the network service or specifically provided for to the particular account or user.

According to some embodiments, the local memory 330 stores each e-book as a record 326 that includes metadata 327 and content 329 (e.g., page content). The management module 320 can retrieve portions of the content 329 for individual e-books for purpose of rendering e-books via the user interface 310. Additionally, the management module 320 can retrieve metadata 327 to render metadata content (e.g., representations of e-books or lists of e-books) with the user interface 310.

In an example of FIG. 3, the user interface 310 of e-reading system 300 includes an e-reading component 308 and a library viewer 312. The e-reading component 308 can include functionality to (i) render page views 315 from a particular e-book, and (ii) detect page events 313. The page views 315 can include the content portion 329 of the e-book being read (e.g., opened or rendered). For example, the e-reading component 308 can display a page view 315 from an e-book corresponding to a novel or periodical, and the page view may include text and/or image content. The page event 313 can correspond to, for example, a page turn, a chapter turn, or a clustered page turn. The library viewer 312 can display metadata content representing a collection or library of e-books, including e-books in the user library.

The user interface 310 can (i) respond to various kinds of user input, including input provided through buttons, switches or other physical input mechanisms, and/or (ii) provide and respond to software-based input features (e.g., icons, touch recognition (e.g., swipe action, press and hold, drag and drop etc.), menu features etc. For example, page events 313 can be generated through a designate user interaction with one or more physical input mechanism and/or software-based features. The user-interface 310 can also provide various other kinds of functionality, such as library viewing, accessing network service 120, purchasing e-books, opening and adjusting settings (e.g., font selection, backlight) for viewing e-books, and/or settings for sharing a reading experience with other users.

According to an embodiment, the e-reading system 300 includes a feature manager 318 which configures the user-interface 310 based on the account (e.g., primary or subordinate) that is selected for a particular use session. In particular, the feature manager 318 can provide physical input configurations 319 which define the response of the user interface 310 to physical input 317. In the example of FIG. 3, the physical input 317 is shown as being received by the feature manager 318, although in implementation, input from physical input mechanisms can be interpreted by alternative programmatic resources. Thus, for example, the physical input configurations 319 can define how the user-interface 310 responds to input made through, for example, a button, keyboard, microphone or switch, when the e-reading component 308 renders page views 315 from an e-book. Based on the configurations 319, the response of the user can correspond to (i) ignoring the physical input 317 (physical input feature is disabled), or (ii) performing a function that is selected and/or configured by the configurations 319.

The feature manager 318 can also signal software-based input configurations 321 to the user interface 310. The software-based input configurations 321 can select the set of input objects for use with the user interface 310 (e.g., icons, menus, etc.). The software-based input configurations 321 can also select the functionality assigned to each of the input objects. Other aspects of the input objects, such as appearance can also be set by the software-based input configurations 321. The feature manager 318 can also signal a modal switch 323, when the user properly initiates a switch to a different account. The modal switch 323 can cause the user interface 310 to implement the physical input configurations 319 and the software-based input configurations 321 of the other mode.

Methodology

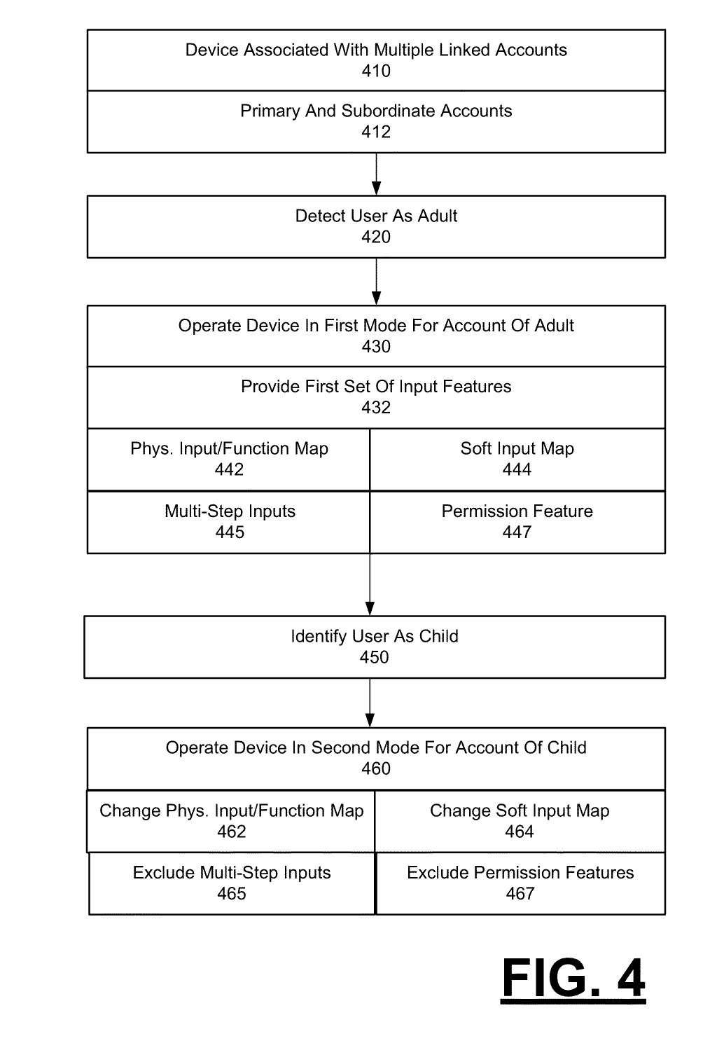

FIG. 4 illustrates an example method for configuring input features of an e-reading device based on an account that is in use on the device, according to an embodiment. An example such as described by FIG. 4 can be implemented using components such as described with FIG. 1, FIG. 2, or FIG. 3. Accordingly, reference may be made to elements of other figures for purpose of illustrating suitable elements or components for performing a step or sub-step being described.

With reference to FIG. 4, the e-reading device 110 is associated with multiple accounts, including two or more accounts that are linked (410). Each account can be established through the network service 120. In one implementation, at least one account can be a primary account, through which a subordinate account is maintained (412). For example, one account can be for an adult (e.g., a parent or guardian), who establishes a subordinate account for a dependent (e.g., child).

A session with the computing device can be initiated. For example, the user can launch an e-reading application, or switch the e-reading device to an operational power state. When the session is initiated, the user is detected (420). The user can be detected as an adult by default, or in response to the user performing some action like providing a password to access the device or resources on the device.

When the user is identified as the adult, the e-reading device is operated using the adult account, and the device implements a first mode for the account of the adult (430). In an example, the account of the adult can be the default account and fully functional. In the first mode, a first set of input features is implemented (432). The first set of input features can include definitions for input processed through interaction with physical input mechanisms (442), including enabling physical input features and defining the action that can be performed through user interaction with such features. As an addition or alternative, the first set of input features can include configurations for software-based input features (444), including selection of software-based features and determination of the function provided with such inputs.

As another variation or addition, the selection of the mode can enable or disable certain kinds of input. For example, some mufti-step inputs requiring physical steps from the user can be enabled when the e-reading device operates in the first mode, and disabled when the device operates in the second mode (445). The mufti-step inputs can be disabled under the premise that such inputs are better suited for use by adult and not by children. Examples of mufti-step inputs includes multi-tap input, drag and drop input on a display screen (or click and drag using clicker device), press and hold (e.g., on button), multi-touch input on display screen, etc.

Still further, some kinds of input actions can be permission based, and the ability of the user to perform the permission based activity can depend on the mode pf operation for the device (447). For example, an input feature can be provided to enable a user to download and purchase an e-book. Such an input action can be permitted when, for example, the device operates in the mode associated with the primary account.

The e-reading device can also identify the user for the subordinate account. For example, the e-reading device can identify the user as a child (450).

The mechanism for identifying users in either (420) or (450) can vary. In one implementation, the user is identified by way of input provided by the user to select an account. In some cases, the user can be required to login, provide a password or perform some other operation in order to access the primary account with use of the e-reading device. In another implementation, biometric information, such as provided through a fingerprint or retina scanner, can be used to identify the user for purpose of selection of the primary or subordinate account.

When the user is identified as the child, the e-reading device can be operated in a second mode in connection with the account of a child (460). In an example, the account of the child can only be accessible through the account of the adult. Thus, the e-reading device may require both accounts to be provided on the device. In the second mode, a second set of input features is implemented. The second set of input features can include alternative definitions for input processed through interaction with physical input mechanisms (462), including enabling or disabling physical input features and defining the actions that can be performed through user interaction with such features. As an addition or alternative, the second set of input features can include configurations for software-based input features (464). The configurations that are implemented in connection with different modes can be selected based on a class of the user. For example, in the second mode, some mufti-step inputs requiring physical steps from the user can be disabled under the premise that such inputs are too difficult for younger users (465). Examples of mufti-step inputs that can be disabled or at least limited include drag and drop input on a display screen (or click and drag using clicker device), press and hold (e.g., on button), mufti-touch input on display screen, etc.

Still further, some kinds of input actions for permission based activity can be disabled or limited when the e-reading device is operated in the second mode (467). For example, when the e-reading device is operated in the second mode, an input feature provided with the first mode for enabling a user to download and purchase an e-book can be disabled.

### EXAMPLES

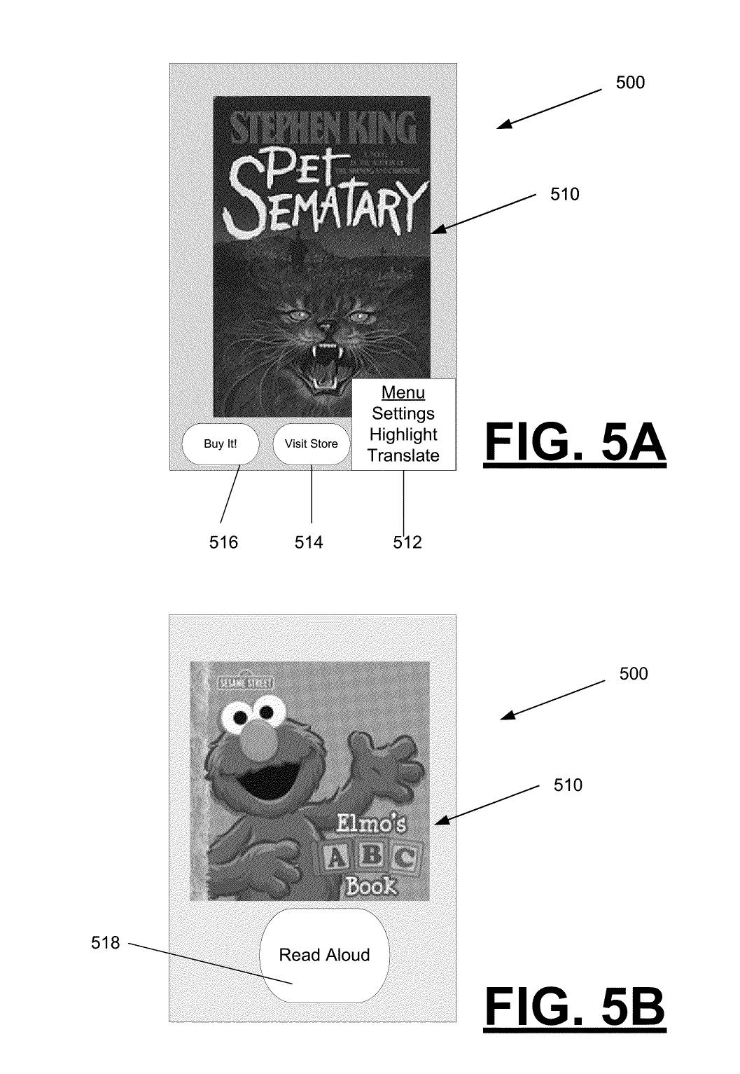

FIG. 5A illustrates an e-reading device that is operated in a primary mode, coinciding with use of a primary account on the e-reading device. FIG. 5B illustrates an e-reading device that is operated in a secondary mode, coinciding with use of a subordinate account on the e-reading device. In describing examples of FIG. 5A and FIG. 5B, reference may be made to elements of prior examples for purpose of providing context and illustrating components for enabling examples as described.

With reference to FIG. 5A, an example of a primary mode provides for an interface 510 on an e-reading device 500. The primary mode can be implemented in connection with an instance or session of the e-reading device utilizing a primary account of the network service 120. In the example provided, a set of software-based features are provided to enable different kinds of functionality. For purpose of simplicity, an example of FIG. 5A illustrates software-based features which are provided when the e-reading device 500 is operated in the primary mode, but not in the secondary mode. In the example provided, the software-based features include a menu set 512 which enables the user to select specific functions such as settings, highlighting and translating. The software-based features also include an icon 514 and 516, each of which are selectable to cause the e-reading device 500 to access the network service 120 to view and/or purchase a specific e-book (e.g., such as e-book being previewed, shown as PET SEMATARY).

In the example of FIG. 5B, the e-reading device 500 is operated in a secondary mode, coinciding with e-reading device being used with the subordinate account of the primary account. In an example shown, the interface 510 of the e-reading device 500 displays a different set of software-based input features. For example, the menu set 512 can be eliminated or changed, under the premise that the functionality provided with the menu set 512 is too advanced for the user class (e.g., child) of the subordinate account. Likewise, the icons 514, 516 can be eliminated from the interface 510 when the e-reading device 500 is operated in the secondary mode because the user class (e.g., child) may not have permission to have access (or certain kinds of access) from the network service 120. However, the interface 510 can generate a feature (icon 518) for the secondary mode which is not provided on the primary mode. For example, the feature 518 can be provided based on a determination of desirable functionality for users of a particular class. As an alternative or variation, the e-reading device 500 can operate in the secondary mode to display an alternative menu set, such as one which changes some or all of the features provided through the menu set.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for operating a computing device, the method being implemented by one or more processors and comprising:
associating the computing device with multiple linked accounts for accessing content items from a network service, the multiple accounts including a primary account and a subordinate account that is available through the primary account;
when the computing device uses the primary account and not the subordinate account, operating the computing device in a first mode in which a first set of input features and a corresponding first set of functionality are provided in order to render content from the network service on the computing device; and
when the computing device uses the subordinate account, operating the computing device in a second mode in which a second set of input features and a corresponding second set of functionality are provided in order to render content from the network service on the computing device.

2. The method of claim 1, wherein the subordinate account is a for a minor or child who is a parent or guardian of the primary account, and wherein the second set of input features is less than the first set of input features.

3. The method of claim 1, further comprising:
determining a user of the computing device, and
switching between the first mode and the second mode based on the determined user.

4. The method of claim 3, wherein detecting the user of the computing device includes processing biometric input from the user.

5. The method of claim 1, wherein the first set of input features includes a set of physical input mechanisms in which each physical input mechanism of the set is assigned to a corresponding function when the computing device operates in the first mode, and wherein the second set of input features includes at least one physical input mechanism from the set that is assigned to a different function than the corresponding function when the computing device operates in the second mode.

6. The method of claim 1, wherein the first set of input features includes a set of physical input mechanisms in which each physical input mechanism of the set is assigned to a corresponding function when the computing device operates in the first mode, and wherein at least one of the physical input mechanisms is disabled for when the computing device operates in the second mode.

7. The method of claim 1, wherein the first set of input features includes a first set of software-based input features, and wherein the second set of input features includes a second set of software-based input features that is different than the first set of software-based input features.

8. The method of claim 7, wherein the first set of input features includes one or more of (i) a drag and drop feature, (ii) a press and hold feature, and/or (iii) a mufti-tap feature.

9. The method of claim 1, wherein the first set of input features includes a feature to initiate and/or complete a transaction to obtain a content item from the network service, and wherein the second set of input features disables or excludes the feature.

10. The method of claim 1, wherein the first set of input features includes a menu with a first set of menu features, and wherein the second set of input features includes the menu with a second set of menu features that is different than the first set of menu features.

11. A computing device comprising:
a network interface;
a memory that stores a set of instructions;
one or more input resources; and
one or more processors that use instructions from the set of instructions to:
use the network service to associate the computing device with multiple linked accounts and to use the linked accounts to access content items from a network service, the multiple accounts including a primary account and a subordinate account that is available through the primary account;
when the computing device uses the primary account and not the subordinate account, operating in a first mode in which a first set of input features and a corresponding first set of functionality are provided using the one or more input resources in order to render content from the network service on the computing device; and
when the computing device uses the subordinate account, operating the computing device in a second mode in which a second set of input features and a corresponding second set of functionality are provided using the one or more input resources in order to render content from the network service on the computing device.

12. The computing device of claim 11, wherein the subordinate account is a minor account for a parent or guardian of the primary account, and wherein the second set of input features is less than the first set of input features.

13. The computing device of claim 11, wherein the one or more processors use the instructions in memory to:
determine a user; and
switch between the first mode and the second mode based on the determined user.

14. The computing device of claim 13, wherein the one or more processors detect the user of the computing device by processing biometric input from the user.

15. The computing device of claim 11, wherein the one or more input resources include a set of physical input mechanisms, and wherein the first set of input features includes a first physical input mechanism from the set, the first physical input mechanism being assigned to a first function when the computing device operates in the first mode, and wherein the second set of input features includes the first physical input mechanism, the first physical input mechanism being assigned to a second function that is different than the first function when the computing device operates in the second mode.

16. The computing device of claim 11, wherein the one or more input resources include a set of physical input mechanisms in which each physical input mechanism of the set is assigned to a corresponding function when the computing device operates in the first mode, and wherein at least one of the physical input mechanisms is disabled when the computing device operates in the second mode.

17. The computing device of claim 11, wherein the one or more input resources include a touch-sensitive display, and wherein the one or more processors provide a first set of software-based input features on the touch-sensitive display when the computing device operates in the first mode, and wherein the one or more processors provide a second set of software-based input features that is different than the first set of software based input features.

18. The computing device of claim 17, wherein the first set of input features includes a given one or more features of (i) a drag and drop feature, (ii) a press and hold feature, and/or (iii) a multi-tap feature, and wherein the second set of input features excludes the given one or more features.

19. The computing device of claim 17, wherein the first set of input features includes a feature to initiate and/or complete a transaction to obtain a content item from the network service, and wherein the second set of input features disables or excludes the feature.

20. A non-transitory computer-readable medium that stores a set of instructions, the instructions being executable by one or more processors: to cause the one or more processors to perform operations comprising:
associating the computing device with multiple linked accounts for accessing content items from a network service, the multiple accounts including a primary account and a subordinate account that is available through the primary account;
when the computing device uses the primary account and not the subordinate account, operating the computing device in a first mode in which a first set of input features and a corresponding first set of functionality are provided in order to render content from the network service on the computing device; and
when the computing device uses the subordinate account, operating the computing device in a second mode in which a first set of input features and a corresponding second set of functionality are provided in order to render content from the network service on the computing device.
